(19) United States
(12) Patent Application Publication
(10) Pub. No.: US 2023/0333362 A1
(43) Pub. Date: Oct. 19, 2023

(54) Apparatus And Method For Combined Use Of Two Independent Monoculars

(71) Applicant: UAB "Yukon Advanced Optics Worldwide", Vilnius (LT)

(72) Inventors: Vladimir DASIUKEVICH, Glasgow (GB); Aliaksandr ALSHEUSKI, Vilnius (LT)

(21) Appl. No.: 17/780,025

(22) PCT Filed: Mar. 26, 2021
(86) PCT No.: PCT/IB2021/052510

§ 371 Date: May 26, 2022

(51) Int. Cl. G02B 23/18; G02B 7/12

(52) U.S. Cl. CPC G02B 23/18; G02B 7/12

(57) ABSTRACT

The present invention presents an optical apparatus and a method for combined use of at least two independent optical observation devices. At least two different and independent optical monoculars, designed for operating independently from each other in different light spectrumparts, are combined together. The independent optical monoculars are linked mechanically and electronically into a single optical system. At least two independent viewfinders and processors are electronically linked to each other. Electronic connection can be provided wired or wireless. The method for combined use of optical monoculars generates a single fused image from different light spectrum parts. An improved and detailed images are generated, which include data from different light spectrum parts. The fused image is generated dynamically in a real time mode. Signals from Near Infrared, visible light, ultraviolet light, Midwave Infrared, Longwave Infrared, Shortwave Infrared and other light spectrum parts could be combined into a single fused image.

### FIELD OF THE INVENTION

The present invention, in general, relates to the optical systems and devices. In particularly, this invention presents a method and an apparatus for combined use of two independent optical observation devices.

### DISCUSSION OF BACKGROUND ART

Hand-held monoculars are made to enhanced natural human viewing experience and can be made utilizing different technologies that convert a light spectrum into a visible image. Some optical monoculars, such as conventional monoculars or range finding monoculars, operating in the visual light spectrum part, optically magnify the view. Different technologies could be used to obtain different light spectrum images, such as Near Infrared (NIR), visible light, ultraviolet (UV) light, Midwave Infrared (MWIR), Longwave Infrared (LWIR), Shortwave Infrared (SWIR) etc. Different technologies have advantages in different circumstances, for example thermal monoculars using LWIR technology can detect objects using their heat signature in complete darkness but may suffer from a low resolution. Operating in NIR part of the spectrum, monoculars can produce more detailed images but may lack sensitivity in low light environment. A solution to get a good image quality in different light circumstances would be to combine different technologies into one device and to produce one merged image.

Combination of multisensory channels are already known. There are so called “fusion” devices, which incorporate a number of detecting channels that operate in different part of a spectrum. Such “fusion” devices can produce a fused image, more complete and more enhanced image. Such an example is presented in a patent application WO2001072033A1 (published on Sep. 27, 2001). The invention discloses a system and a device for combining multi-spectral images of a scene. There are two detectors for viewing the scene in a first and a second spectral bands. The device comprises a display for receiving and displaying the image output, and a collimator for receiving and projecting the displayed image. The device also comprises a beam mixer for receiving the viewed scene in both spectral bands and for conveying the combined images to the viewing system. The combined multi-spectral images of the scene are constructed. However, such and similar devices are complex fusion vision systems. Complex images are generated after the fusion of the signals of different spectral bands. Such devices are usually expensive, have a substantial size and weight, also have no flexibility in reconfiguration.

Another approach employs a method, when two monoculars are combined to form a binocular system. A patent application US2012069431A1 (published on Mar. 22, 2012), presents an optical assembly comprising a connecting bridge to link up two optical units. Two autonomous optical units are mechanically coupled to each other. The connecting bridge is fitted each time with at least one coupling for each optical unit. However, two autonomous optical units are of the same kind and captures the light from the same light spectrum part, such as just a visible light, or just an infrared light. Therefore, more detailed images are not produced.

Our proposed method and the device, based on this method, avoid disadvantages of the above-described methods and present a simple method for obtaining an improved and detailed images.

### SUMMARY OF THE INVENTION

The present invention presents an optical apparatus and a method for combined use of at least two independent optical observation devices. At least two different and independent optical monoculars, designed for operating independently from each other in different light spectrumparts, are combined together. The independent optical monoculars are linked mechanically and electronically into a single optical system. At least two independent viewfinders and processors are electronically linked to each other. Electronic connection can be provided wired or wireless. The method for combined use of optical monoculars generates a single fused image from different light spectrum parts. An improved and detailed images are generated, which include data from different light spectrum parts. The fused image is generated dynamically in a real time mode. Signals from Near Infrared, visible light, ultraviolet light, Midwave Infrared, Longwave Infrared, Shortwave Infrared and other light spectrum parts could be combined into a single fused image.

### BRIEF DESCRIPTION OF THE DRAWINGS

FIG. 1. depicts optical monoculars. FIG. 1A depicts two independent optical monoculars. FIG. 1B depicts an apparatus, comprising two combined optical monoculars.

### DETAILED DESCRIPTION OF THE INVENTION

Monoculars are optical devices, used to transform an image. The transformation can be optical, electronic or a combination of both. Monoculars could use different technologies to obtain images from different light spectrum parts, such as Near Infrared (NIR), visible light, ultraviolet (UV) light, Midwave Infrared (MWIR), Longwave Infrared (LWIR), Short wave Infrared (SWIR) etc.

Usually, a single monocular is operating in just a single light spectrum part. Some inventions present a monocular system, when two monoculars of the same kind are connected together.

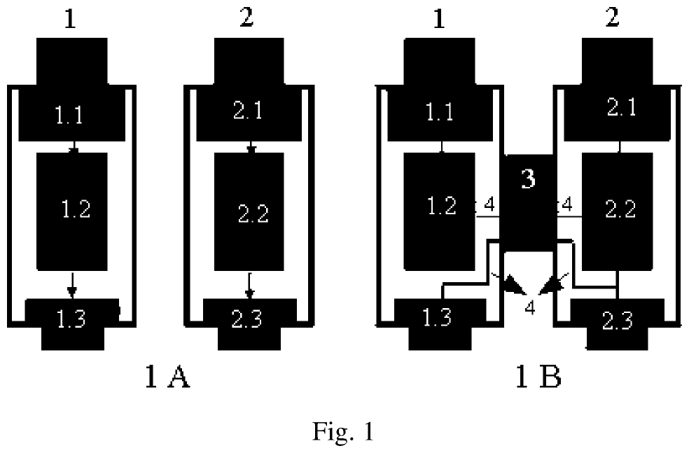

The present invention discloses an optical apparatus comprising at least two different optical monoculars, operating in different light spectrum parts, and a connecting bridge between them (FIG. 1). On the left side of the figure, there are two independent, not connected monoculars (FIG. 1A), while on the left side of the figure, there are two combined monoculars (FIG. 1B). In particular, the present invention discloses an optical apparatus comprising:
a first optical monocular (1);
a second optical monocular (2);
a mechanical mount (3) between the optical monoculars (1 and 2);
an electronic interfacing (4) between the optical monoculars (1 and 2) (FIG. 1B).

Optical monoculars (1 and 2) comprise a camera (1.1 or 2.1), a processor (1.2 or 2.2) and a viewfinder (1.3 or 2.3). The camera (1.1 or 2.1) is an optical system, which has lens with a variable diaphragm for focusing the light, prisms, or both. The camera (1.1 or 2.1) receives the light signal, focuses the light signal and sends it to the processor (1.2 or 2.2). The processor (1.2 or 2.2) is an electronic device, which receives the signal from the camera (1.1 or 2.1), performs image processing and sends the image to the viewfinder (1.3 or 2.3). The viewfinder (1.3 or 2.3) is a device adapted for a monocular to look through to compose and to focus the image.

In the present invention, at least two monoculars (1 and 2) are combined together, they are connected mechanically and electronically (FIG. 1B). The mechanical mount (3) between the optical monoculars (1 and 2) is any of the mechanical means, which allow to link mechanically at least two optical monoculars (1 and 2) and to adjust a distance between them. The mechanical mount (3) provides secure mechanical and electronic connection between the two optical monoculars (1 and 2). It also allows a mechanical alignment to align fields of view of the two optical monoculars (1 and 2) as well as to adjust for the most suitable eye span.

The electronic interfacing (4) between the optical monoculars (1 and 2) could be executed by any means of wired connections via mechanical connectors, by a wireless communication between at least two optical monoculars (1 and 2), or by both mechanical connectors and a wireless communication. The electronic interfacing (4) connects the viewfinders (1.3 and 2.3) and the processors (1.2 or 2.2) of different optical monoculars (1 and 2) into a single system. Therefore, the viewfinders (1.3 and 2.3) of independent monoculars (1 and 2) operate not independently on each other, but as a single system and deliver a processed fused image from the data, obtained from at least two monoculars (1 and 2). The electronic interfacing (4) is designed for obtaining fused images: different images, obtained from different monoculars (1 and 2), are overlayed and fused into a single image. The fused image is an enhanced image with more details in comparison with the image obtained from just a single monocular, since at least two images from different light spectrum parts are combined, fused into a single image.

If the optical monoculars (1 and 2) are not combined, they are operating independently from each other (FIG. 1A). When at least two independent optical monoculars (1 and 2) are combined, they are operating as a single optical system, dependently from each other (FIG. 1B). The combined optical monoculars (1 and 2) are orientated co-axially, which allows to obtain a corresponding fused image from an overlapping field of view. The combined optical monoculars can be mechanically adjusted for a comfortable eye span distance to accommodate the fact that different users can have different eye span distance.

The apparatus for combined use of two independent monoculars comprise at least two optical monoculars (FIGS. 1B, 1 and 2).

In one embodiment of the present invention, at least two optical monoculars (1 and 2) of the same kind are connected to each other and are operating in the same light spectrum part. The cameras (1.1 and 2.1) and the processors (1.2 and 2.2) are designed for operating in the same light spectrum part. For example, the combined optical monoculars (0 and 2) could be operating in the visual light spectrum part, or in the infrared light spectrum part, or in the ultraviolet light spectrum part.

In another embodiment of the present invention, at least two different optical monoculars (1 and 2) are combined. The first optical monocular (1) and the second optical monocular (2) are operating in different light spectrum parts. In this embodiment, the cameras (1.1 and 2.1) and the processors (1.2 and 2.2) are designed for operating in different light spectrum parts. When the optical monoculars (1 and 2) are combined, the viewfinders (1.3 and 2.3) are operating as a single system and compose a fused image from different light spectrum parts.

In one embodiment of the present invention, the first optical monocular (1) could be operating in the visual light spectrum part, and the second optical monocular (2) could be operating in the infrared light spectrum part. Therefore, it is practically possible to combine digital thermal monocular (1) with the visual light spectrum part (day light vision) optical instrument (2). The visual light spectrum part optical instrument (2) could be a day light vision optical monocular (2) or a rangefinder (2). Usually it is not possible to control fully a viewfinder (2.3) of a conventional visual light spectrum optical monocular (2). When the two optical monoculars (1 and 2) are combined, the digital thermal monocular (1) can definitely detect that the conventional visual light spectrum optical monocular (2) is attached to it and can readjust its parameters. The viewfinder (1.3) of the digital thermal monocular (1) magnifies or diminishes the size of the obtained thermal image to match the thermal image with the visual image, obtained from the visual light spectrum optical monocular (2). After the thermal image size, position and other parameters are adjusted with the optical image, the digital thermal monocular (1) can work coherently with the visual light spectrum optical monocular (2), the optical monocular (2) or the day light vision rangefinder (2). There could be several variations, how the digital thermal monocular (1) and the visual light spectrum optical monocular (2) are combined together. In one embodiment, the visual light spectrum optical monocular (2) is the day light vision rangefinder (2). The data from the rangefinder (2) can be duplicated and transferred to the digital thermal monocular (1). In this case, the visual light spectrum optical monocular (2) presents a single, not combined, visual light spectrum image, while the digital thermal monocular (1) presents a fused optical image, obtained from both optical monoculars (1 and 2). Additionally, the day light vision rangefinder (2) could have some indicator(s), showing that it is connected to the digital thermal monocular (1).

In another embodiment of the present invention, the first optical monocular (1) could be operating in the visual light spectrum part, and the second optical monocular (2) could be operating in the UV light spectrum part.

In yet another embodiment of the present invention, the first optical monocular (1) could be operating in the LWIR, or SWIR, or MWIR light spectrum part, and the second optical monocular

(2) could be operating in the UV light spectrum part.

In yet another embodiment of the present invention, there could be more than two optical monoculars (1 and 2), for example, three, four or more, connected to each other. All of the optical monoculars could be operating in different light spectrum parts, or some of the monoculars could be operating in the same light spectrum part, while other monoculars—in a different light spectrum parts. There could be many combinations: some of the optical monoculars (1 or 2) could be operating in one light spectrum part, while other optical monoculars (1 or 2) could be operating in different light spectrum parts.

As the above-mentioned embodiments show, there are several ways, how the data are combined and presented between the first optical monocular (1) and the second optical monocular (2). In one embodiment of the present invention, the optical images from both optical monoculars (1 and 2) could be matched and combined together, in order to form a single fused image. In another embodiment of the present invention, the optical image from any one of the optical monocular (1 or 2) could be duplicated and transferred to the other combined optical monocular(s) (1 or 2). In this case, the first optical monocular (1) presents a single, not combined, image, while the second optical monocular (2) presents a fused optical image, obtained from both optical monoculars (1 and 2). The optical monoculars (1 or 2) could have some indicator(s), showing that they are connected to the other combined optical monocular(s) (1 or 2).

In order to illustrate and describe the invention, the description of the preferred embodiments is presented above. This is not a detailed or restrictive description to determine the exact form or embodiment. The above description should be viewed more than the illustration, not as a restriction. It is obvious that specialists in this field can have many modifications and variations. The embodiment is chosen and described in order to best understand the principles of the present invention and their best practical application for the various embodiments with different modifications suitable for a specific use or implementation adaptation.

A method for combined use of optical monoculars (1 and 2) employs at least two independent optical monoculars (1 and 2), operating is different light spectrum parts. According to the present invention, when at least two different and independent optical monoculars (1 and 2) are combined to a single optical system (FIG. 1B), the optical monoculars (1 and 2) are operating dependently on each other. At least two independent viewfinders (1.3 and 2.3) and two independent processors (1.2 and 2.2) are mechanically and electronically linked to each other. Therefore, at least two different optical monoculars (1 and 2) are operating as a single optical system, are processing and delivering a single fused image. The cameras (1.1 and 2.1) receive different light signals from different light spectrum part and send the light signals to the processors (1.2 and 2.2). The processors (1.2 and 2.2) process the received light signals from all cameras (1.1 and 2.1) and generate a single fused image, which is presented on the viewfinders (1.3 and 2.3). At least two independent viewfinders (1.3 and 2.3), electronic linked to each other, are operating dependently and are delivering a single fused image. A single fused image is generated from at least two different light spectrum parts. The single fused image is generated by overlapping the corresponding field of view from the different light spectrum parts. In another embodiment of the present system, a single image could be generated from the same light spectrum part.

The cameras (1.1 and 2.1), the processors (1.2 and 2.2) and the viewfinders (1.3 and 2.3) are operating in a real time mode, therefore the fused image is generated dynamically in a real time mode.

1. An optical apparatus comprising at least two optical monoculars and a connecting bridge between at least two optical monoculars, the connecting bridge having a mechanical mount that is designed for a mechanical linking of optical monoculars and for adjusting positioning between at least two independent monoculars,
characterized in that:
at least two optical monoculars are different independent optical monoculars, designed for operating independently from each other in different light spectrum parts for obtaining different images;
the connecting bridge further comprises an electronic interfacing between at least two optical monoculars, the electronic interfacing is designed for connecting electronically at least two optical monoculars,
which allows the optical apparatus, comprising at least two optical monoculars, to obtain a single fused image from different light spectrum parts.

2. The optical apparatus according to the claim 1, characterized in that the optical monoculars comprise at least two independent viewfinders, which are electronic linked to each other.

3. The optical apparatus according to claim 1, characterized in that the optical monoculars comprise at least two independent processors, which are electronic linked to each other.

4. The optical apparatus according to claim 1, characterized in that the electronic interfacing between at least two optical monoculars is performed by the means of wired connections via mechanical connectors, by a wireless communication between at least two optical monoculars, or by both means.

5. The optical apparatus according to claim 1, characterized in that at least two optical monoculars are orientated co-axially, which allows to obtain a single fused image from a combined field of view.

6. The optical apparatus according to claim 1, characterized in that the optical monocular has indicator(s), showing that the current optical monocular is connected to at least one other combined optical monocular.

7. A method for combined use of optical monoculars, characterized in that the method generates a single fused image, obtained by at least two different independent optical monoculars, operating is different light spectrum parts.

8. The method for combined use of optical monoculars according to the claim 7, characterized in that the single fused image is generated by combining the images from the corresponding fields of view, obtained from the different light spectrum parts.

9. The method for combined use of optical monoculars according to claim 7, characterized in that the fused image is generated dynamically in a real time mode.

10. The method for combined use of optical monoculars according to claim 7, characterized in that at least two independent viewfinders, electronically linked to each other, operate dependently on each other, as a single optical system, and deliver a single fused image.

11. The method for combined use of optical monoculars according to claim 7, characterized in that at least two independent processors, electronic linked to each other, operate dependently on each other, as a single optical system and generate a single fused image.

12. The method for combined use of optical monoculars according to claim 7, characterized in that the optical image from any one of the optical monocular could be duplicated and transferred to the other combined optical monocular(s); the first optical monocular (1) presents a single, not combined, image, while the remaining optical monocular(s) present a fused optical image, obtained from at least two optical monoculars.
